(19) United States
(12) Patent Application Publication
(10) Pub. No.: US 2026/0246163 A1
(43) Pub. Date: Aug. 20, 2026

(54) POWER TERMINAL ASSEMBLY

(71) Applicant: TE Connectivity Solutions GmbH, Schaffhausen (CH)

(72) Inventors: Pushkar S. Kolhatkar, Troy, MI (US); Logan Mankaryos, Winston Salem, NC (US)

(21) Appl. No.: 19/058,940

(22) Filed: Feb. 20, 2025

(51) Int. Cl. H01R 4/16; H01R 13/04

(52) U.S. Cl. CPC H01R 4/16; H01R 13/04

(57) ABSTRACT

A power terminal assembly includes a power terminal that has a first panel and a second panel arranged back-to-back. The first panel includes a first mating end configured to be mated to a mating power terminal and a first terminating end configured to be terminated to a power conductor. The first panel includes a first window at the first terminating end and a first contact bridge at the first terminating end. The second panel includes a second mating end configured to be mated to the mating power terminal and a second terminating end configured to be terminated to the power conductor. The second panel includes a second window at the second terminating end and a second contact bridge at the second terminating end. The first window receives the second contact bridge. The second window receives the first contact bridge for termination to the power conductor.

### BACKGROUND OF THE INVENTION

The subject matter herein relates generally to power terminal assemblies.

Power terminals are used to transmit power between various components of a system. The power terminals may be integrated into housings of electrical connectors to create a connectorized mating interface. The power terminals have complimentary mating interfaces. For example, one half of the mating interface may include a male interface, such as a pin or blade contact, and the other half of the mating interface may include a female interface, such as a socket or receptacle contact. It may be desirable to increase the size of the power terminals to increase the current capacity across the interface. For example, some known power terminals are folded-over male terminals to increase the size of the power terminals. Smaller gauge stock may be used, which is less expensive than larger gauge stock and can be held to tighter tolerances. A power cable or busbar may be welded to one side or the other of the folded-over male terminal. However, such power terminals have long path lengths from one side of the power terminal to the other side of the power terminal leading to inefficient current flow along the power terminal.

A need remains for a power terminal having improved current flow through the power terminal.

### BRIEF DESCRIPTION OF THE INVENTION

In one embodiment, a power terminal assembly is provided and includes a power terminal that has a first panel and a second panel arranged back-to-back. The first panel includes a first mating end configured to be mated to a mating power terminal and a first terminating end configured to be terminated to a power conductor. The first panel includes a first window at the first terminating end and a first contact bridge at the first terminating end. The second panel includes a second mating end configured to be mated to the mating power terminal and a second terminating end configured to be terminated to the power conductor. The second panel includes a second window at the second terminating end and a second contact bridge at the second terminating end. The first window receives the second contact bridge. The second window receives the first contact bridge for termination to the power conductor.

In another embodiment, a power terminal assembly is provided and includes a power conductor that has a mating interface. The power terminal assembly includes a power terminal terminated to the mating interface of the power conductor. The power terminal has a first panel at a first side of the power terminal and a second panel at a second side of the power terminal. The first and second panels arranged back-to-back. The first panel includes a first mating end configured to be mated to a mating power terminal and a first terminating end configured to be terminated to the power conductor. The first panel includes a first window at the first terminating end and a first contact bridge at the first terminating end. The second panel includes a second mating end configured to be mated to the mating power terminal and a second terminating end configured to be terminated to the power conductor. The second panel includes a second window at the second terminating end and a second contact bridge at the second terminating end. The first window receives the second contact bridge such that the first panel and the second contact bridge are both configured to be terminated to the power conductor when the power conductor is at the first side. The second window receives the first contact bridge such that the second panel and the first contact bridge are both configured to be terminated to the power conductor when the power conductor is at the second side.

In a further embodiment, a power connector is provided and includes a connector housing that has a terminal channel. The power connector includes a power terminal received in the terminal channel and held by the connector housing. The power terminal includes a power conductor that has a mating interface, and a power terminal terminated to the mating interface of the power conductor. The power terminal has a first panel at a first side of the power terminal and a second panel at a second side of the power terminal. The first and second panels are arranged back-to-back. The first panel includes a first mating end configured to be mated to a mating power terminal and a first terminating end configured to be terminated to the power conductor. The first panel includes a first window at the first terminating end and a first contact bridge at the first terminating end. The second panel includes a second mating end configured to be mated to the mating power terminal and a second terminating end configured to be terminated to the power conductor. The second panel includes a second window at the second terminating end and a second contact bridge at the second terminating end. The first window receives the second contact bridge such that the first panel and the second contact bridge are both configured to be terminated to the power conductor when the power conductor is at the first side. The second window receives the first contact bridge such that the second panel and the first contact bridge are both configured to be terminated to the power conductor when the power conductor is at the second side.

### BRIEF DESCRIPTION OF THE DRAWINGS

FIG. 1 illustrates a power connector including a power terminal assembly in accordance with an exemplary embodiment.

FIG. 2 is a front perspective view of the power terminal assembly in accordance with an exemplary embodiment.

FIG. 3 is a rear perspective view of the power terminal assembly in accordance with an exemplary embodiment.

FIG. 4 illustrates an outer side of a stamped metal blank used to form the power terminal in a pre-formed (stamped) state.

FIG. 5 illustrates an inner side of a stamped metal blank used to form the power terminal in the pre-formed (stamped) state.

FIG. 6 is a rear perspective view of the first side of the power terminal in a formed state in accordance with an exemplary embodiment.

FIG. 7 is a rear perspective view of the second side the power terminal in the formed state in accordance with an exemplary embodiment.

### DETAILED DESCRIPTION OF THE INVENTION

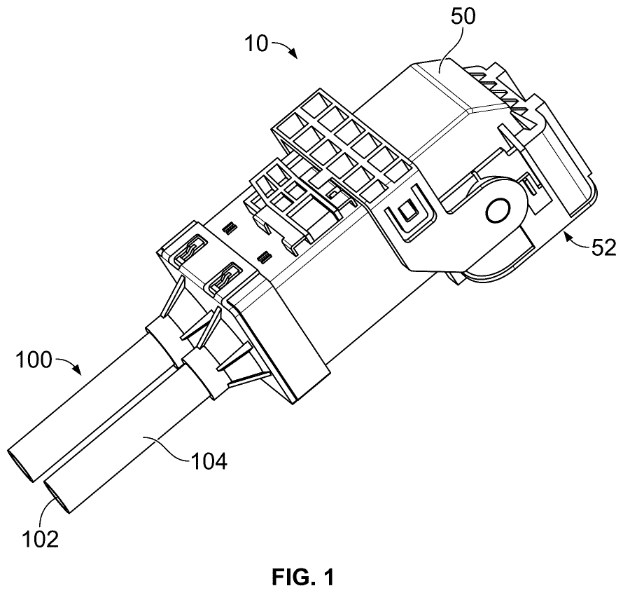

FIG. 1 illustrates a power connector 10 including a power terminal assembly 100 in accordance with an exemplary embodiment. The power connector 10 may include multiple power terminal assemblies 100. For example, the power connector 10 may include a pair of the power terminal assemblies 100. Greater or fewer power terminal assemblies 100 may be provided in alternative embodiments.

The power connector 10 is configured to be mated with a mating power connector (not shown). For example, the power connector 10 may be a plug connector configured to be mated with a receptacle connector or header connector defining the mating power connector. The power terminal assemblies 100 are configured to be electrically connected to the mating power terminals (not shown) held by the mating power connector. The system is configured to transmit power between the power connector 10 in the mating power connector, such as to supply power to one or more components. The power connector 10 may additionally or alternatively be used for data communication. For example, the power connector 10 may include one or more data or signal contacts.

The power connector 10 may be used in various systems or applications. For example, the power connector 10 may be used in an automotive application, an aeronautical application, a military application, an industrial application, a computer or network application, or other application, system, machine or device.

The power connector 10 includes a connector housing 50 having one or more terminal channels 52 that receive the corresponding power terminal assemblies 100. In the illustrated embodiment, the connector housing 50 is generally box shaped having a top, a bottom, a front, a rear, and opposite sides. The connector housing 50 may have other shapes in alternative embodiments. The connector housing 50 may be manufactured from a dielectric material, such as a plastic material. For example, the connector housing 50 may be a molded part.

In various embodiments, the connector housing 50 may include an electrical shield. The connector housing 50 may include one or more mounting features for mounting the connector housing 50 to another component, such as a panel, a chassis, a frame, or other component. The connector housing 50 may include a latching feature configured to be latched to the mating power connector to secure the power connector 10 to the mating power connector.

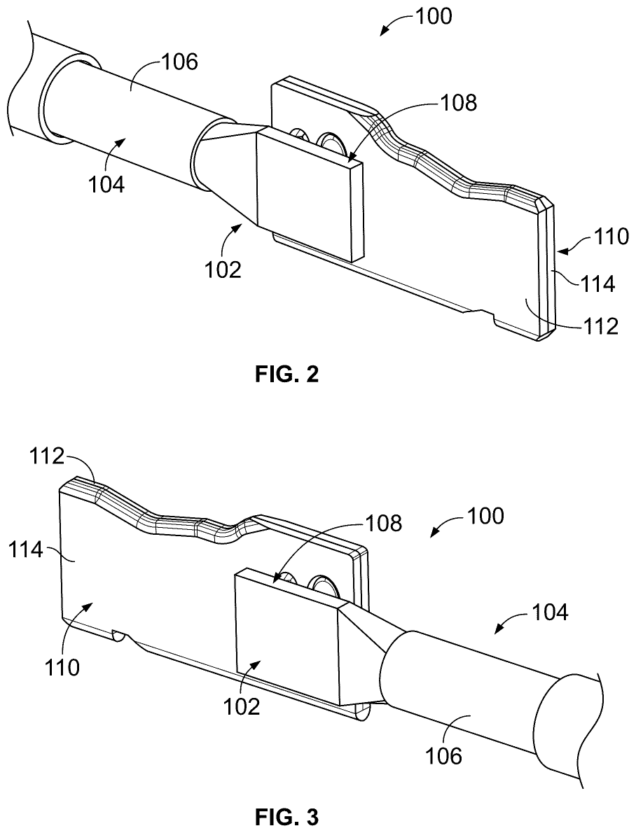

With additional reference to FIGS. 2 and 3, the power terminal assembly 100 includes a power conductor 102 and a power terminal 110 terminated to the power conductor 102. For example, an end of the power conductor 102 may be welded to the power terminal 110. The power terminal 110 is held by the connector housing 50 for mating with the mating power connector. In various embodiments, the power terminal 110 may be enclosed or surrounded by the connector housing 50. In alternative embodiments, the power terminal 110 may extend from the connector housing 50, such as forward from the front of the connector housing 50.

In the illustrated embodiment, the power conductor 102 includes a power cable 104. The power cable 104 extends from the cable end of the connector housing 50. The power cable 104 may be routed to another component within the system. Optionally, multiple power cables 104 may be bundled together. In alternative embodiments, the power conductor 102 may include a busbar rather than the power cable 104. The busbar is configured to be terminated to the power terminal 110. For example, the busbar may be welded to the power terminal 110.

FIG. 2 is a front perspective view of the power terminal assembly 100 in accordance with an exemplary embodiment. FIG. 3 is a rear perspective view of the power terminal assembly 100 in accordance with an exemplary embodiment. The power terminal assembly 100 includes the power terminal 110 in the power conductor 102. FIG. 1 illustrates the power conductor 102 terminated to a first side 112 of the power terminal 110. FIG. 3 illustrates the power conductor 102 terminated to a second side 114 of the power terminal 110. The power conductor 102 may be terminated to either the first side 112 or the second side 114. For example, the power conductor 102 may be welded to either the first side 112 or the second side 114. In an exemplary embodiment, the power terminal 110 is designed for efficient current flow between the power terminal 110 and the power conductor 102.

In the illustrated embodiment, the power conductor 102 includes the power cable 104. The power conductor 102 includes an insulator 106 surrounding the center conductor, such as the power cable 104. In an exemplary embodiment, the power conductor 102 includes a mating interface 108 at an end of the power conductor 102. The mating interface 108 is configured to be coupled to the power terminal 110, such as being welded to the power terminal 110. Optionally, the power conductor 102 may be flattened at the mating interface 108 for welding to the power terminal 110.

In various embodiments, the power cable 104 may be a round power cable. In other embodiments, the power cable 104 may be a flat power cable. The power cable 104 may be a stranded wire cable in various embodiments. Alternatively, the power cable 104 may be a solid core cable, such as an extruded cable. In alternative embodiments, the power conductor 102 may include a busbar, such as a flat metal plate.

In an exemplary embodiment, the power terminal 110 is a male terminal. For example, the power terminal 110 is a blade terminal, a tab terminal, a pin terminal, or other type of male power terminal. In an exemplary embodiment, the power terminal 110 is a stamped and formed power terminal. For example, the power terminal 110 may be stamped from a metal sheet. In an exemplary embodiment, the power terminal 110 is a folded over male terminal having a thickness greater than the single thickness of the metal sheet. For example, the power terminal 110 may be folded in half to have a thickness double the single thickness of the metal sheet to increase the current carrying capacity of the power terminal 110 compared to a power terminal having a single metal sheet thickness.

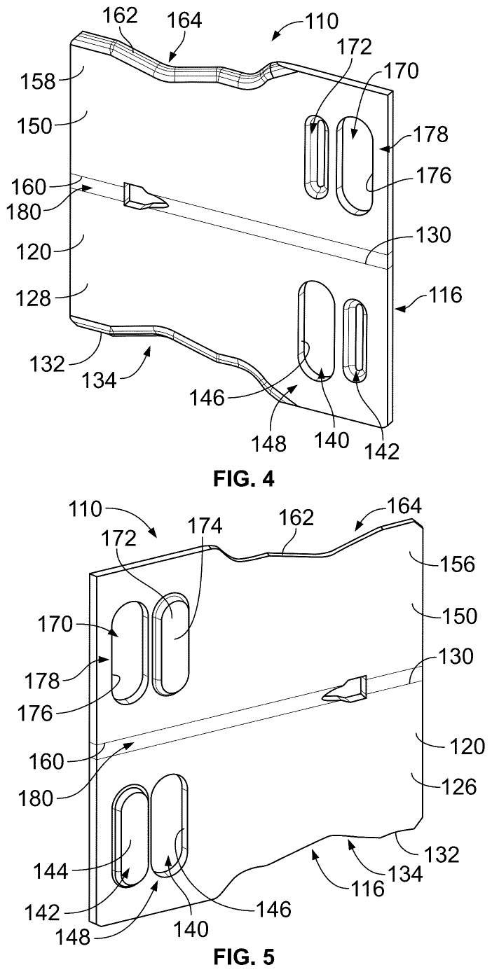

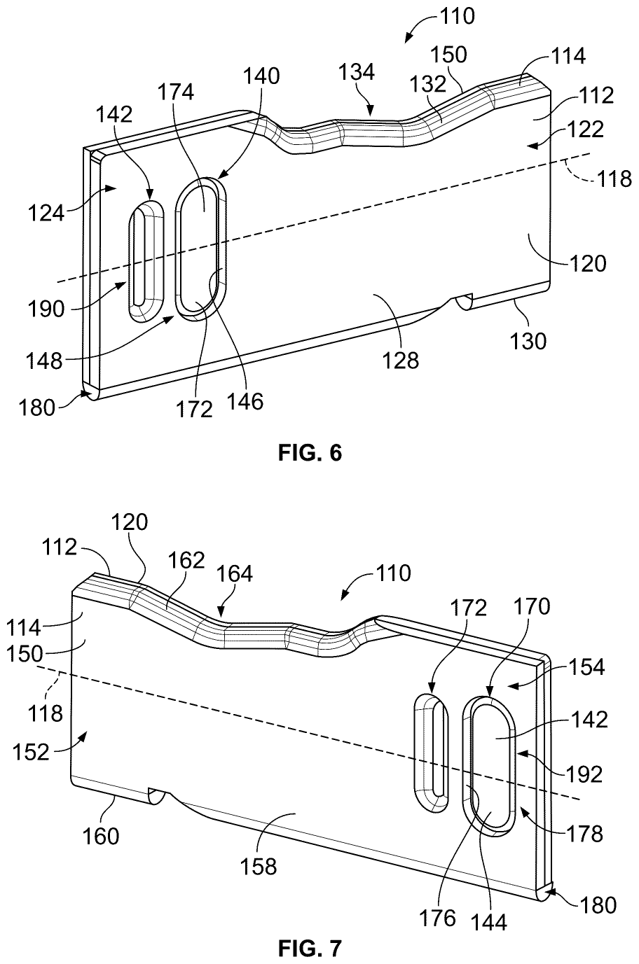

FIG. 4 illustrates an outer side of a stamped metal blank 116 used to form the power terminal 110 in a pre-formed (stamped) state. FIG. 5 illustrates an inner side of a stamped metal blank 116 used to form the power terminal 110 in the pre-formed (stamped) state. FIG. 6 is a rear perspective view of the first side 112 of the power terminal 110 in a formed state. FIG. 7 is a rear perspective view of the second side 114 the power terminal 110 in the formed state. The stamped metal blank 116 may be folded, bent, or otherwise formed into the desired shape of the power terminal 110. For example, the stamped metal blank 116 may be folded in half to form the power terminal 110.

The power terminal 110 includes a first panel 120 at the first side 112 of the power terminal 110 and a second panel 150 at the second side 114 of the power terminal 110. The first and second panels 120, 150 are arranged back-to-back in a stacked arrangement. In an exemplary embodiment, the first and second panels 120, 150 are integral being formed by folding a metal sheet in half. When formed, the power terminal 110 includes a folded seam 180 between the first and second panels 120, 150. The metal blank 116 is folded at the folded seam 180 to position the first and second panels 120, 150 back to back to increase the thickness of the power terminal 110. The first panel 120, the second panel 150, and the folded seam 180 extend longitudinally along a terminal axis 118 of the power terminal 110. The terminal axis 118 may extend between a front and a rear of the power terminal 110. In alternative embodiments, the first and second panels 120, 150 may be separate pieces that are connected or fixed together, such as being soldered, welded, or otherwise secured together.

In an exemplary embodiment, the power terminal 110 has a composite surface at the first side 112 and the second side 114 integrating portions of both panels 120, 150 on each side 112, 114 to improve current flow. For example, a portion of the first panel 120 is provided at the second side 114 to allow direct electrical connection of the first panel 120 and the second panel 150 to the power conductor 102 when the power conductor 102 is terminated to the second side 114. A portion of the second panel 150 is provided at the first side 112 to allow direct electrical connection of the first panel 120 and the second panel 150 to the power conductor 102 when the power conductor 102 is terminated to the first side 112. In an exemplary embodiment, the power terminal 110 establishes efficient current flow to both the first panel 120 and the second panel 150 independent of the side that the power conductor 102 is connected to. In an exemplary embodiment, both panels 120, 150 of the power terminal 110 are involved in current conduction by allowing current flow through both panels 120, 150 directly, without traversing the entire folded length of the power terminal 110 (for example, traversing over the folded seam 180).

The first panel 120 includes a first mating end 122 at a front configured to be mated to the mating power terminal and a first terminating end 124 at a rear configured to be terminated to the power conductor 102. The first panel 120 includes an inner surface 126 and an outer surface 128 opposite the inner surface 126. The inner surface 126 is configured to face the second panel 150 when formed. The outer surface 128 defines a terminating interface for termination to the power conductor 102, such as welding to the power conductor 102.

In an exemplary embodiment, the first panel 120 includes a fixed edge 130 at the folded seam 180 and a distal edge 132 opposite the fixed edge 130. In various embodiments, the fixed edge 130 may be located at a bottom of the first panel 120 and the distal edge 132 may be located at a top of the first panel 120. Other orientations are possible in alternative embodiments. In an exemplary embodiment, the first panel 120 includes a notch or cutout 134 along the fixed edge 130 and/or the folded seam 180. The cutout 134 may form a latching feature for latching or securing the power terminal 110 in the connector housing 50. The first panel 120 may include other types of latching or securing features for secure the power terminal 110 in the connector housing 50. In various embodiments, the distal edge 132 may be straight or linear. In other embodiments, the distal edge 132 may be non-linear, such as including various sections and/or cutouts. In the illustrated embodiment, the first panel 120 has a non-uniform height. For example, the distal edge 132 is non-linear to vary the height along the length of the first panel 120.

In an exemplary embodiment, the first panel 120 includes a first window 140 at the first terminating end 124 and a first contact bridge 142 at the first terminating end 124. The first contact bridge 142 is located adjacent to the first window 140. For example, the first contact bridge 142 may be located axially offset from the first window 140 along the terminal axis 118 of the power terminal 110, such as forward of the first window 140 or rearward of the first window 140. The first contact bridge 142 may be located laterally offset from the first window 140 in a direction transverse or perpendicular to the terminal axis 118 of the power terminal 110, such as above or below the first window 140.

The first contact bridge 142 includes a protrusion 144 extending from the inner surface 126 of the first panel 120. The protrusion 144 protrudes from the inner surface 126 thus extending further inward relative to the inner surface 126. In an exemplary embodiment, the protrusion 144 is configured be received in the second panel 150. For example, the first contact bridge 142 is configured to be received in a corresponding window of the second panel 150 for direct termination to the power conductor 102 when the power conductor 102 is terminated to the second side 114 of the power terminal 110. The first contact bridge 142 may be stamped or formed from the first panel 120. For example, the first contact bridge 142 may be formed by drawing, coining, stretching, denting, die forming, rolling, stamping, punching, extruding or other metal forming process. Alternatively, the first contact bridge 142 may be separately formed and fixed to the inner surface 126, such as being welded to the inner surface 126.

The first window 140 passes through the first panel 120. The first window 140 is defined by an edge 146 between the inner surface 126 and the outer surface 128. The first window 140 may be formed by stamping, cutting, punching or other metal forming process to form the edge 146 and the first window 140. In an exemplary embodiment, the first panel 120 includes a first shroud 148 partially or completely surrounding the first window 140. In the illustrated embodiment, the edge 146 may completely surround the first window 140. For example, the shroud 148 may be located above, below, forward of, and rearward of the first window 140. Alternatively, the shroud 148 may only partially surround the first window 140, such as being open above or below or forward of or rearward of the first window 140.

The second panel 150 includes a second mating end 152 at a front configured to be mated to the mating power terminal and a second terminating end 154 at a rear configured to be terminated to the power conductor 102. The second panel 150 includes an inner surface 156 and an outer surface 158 opposite the inner surface 156. The inner surface 156 is configured to face the inner surface 126 of the first panel 120 when formed. The outer surface 158 defines a terminating interface for termination to the power conductor 102, such as welding to the power conductor 102.

In an exemplary embodiment, the second panel 150 includes a fixed edge 160 at the folded seam 180 and a distal edge 162 opposite the fixed edge 160. In various embodiments, the fixed edge 160 may be located at a bottom of the second panel 150 and the distal edge 162 may be located at a top of the second panel 150. Other orientations are possible in alternative embodiments. In an exemplary embodiment, the second panel 150 includes a notch or cutout 164 along the fixed edge 160 and/or the folded seam 180. The cutout 164 may be aligned with the cutout 134 of the first panel 120. The cutout 164 may form a latching feature for latching or securing the power terminal 110 in the connector housing 50. The second panel 150 may include other types of latching or securing features for secure the power terminal 110 in the connector housing 50. In various embodiments, the distal edge 162 may be straight or linear. In other embodiments, the distal edge 162 may be non-linear, such as including various sections and/or cutouts. In the illustrated embodiment, the second panel 150 has a non-uniform height. For example, the distal edge 162 is non-linear to vary the height along the length of the second panel 150.

In an exemplary embodiment, the second panel 150 includes a second window 170 at the second terminating end 154 and a second contact bridge 172 at the second terminating end 154. The second contact bridge 172 is located adjacent to the second window 170. For example, the second contact bridge 172 may be located axially offset from the second window 170 along the terminal axis 118 of the power terminal 110, such as forward of the second window 170 or rearward of the second window 170. The second contact bridge 172 may be located laterally offset from the second window 170 in a direction transverse or perpendicular to the terminal axis 118 of the power terminal 110, such as above or below the second window 170.

The second contact bridge 172 includes a protrusion 174 extending from the inner surface 156 of the second panel 150. The protrusion 174 protrudes from the inner surface 156 thus extending further inward relative to the inner surface 156. In an exemplary embodiment, the protrusion 174 is configured be received in the first panel 120. For example, the second contact bridge 172 is configured to be received in the first window 140 of the first panel 120 for direct termination to the power conductor 102 when the power conductor 102 is terminated to the first side 112 of the power terminal 110. The second contact bridge 172 may be stamped or formed from the second panel 150. For example, the second contact bridge 172 may be formed by drawing, coining, stretching, denting, die forming, rolling, stamping, punching, extruding or other metal forming process. Alternatively, the second contact bridge 172 may be separately formed and fixed to the inner surface 156, such as being welded to the inner surface 156.

The second window 170 passes through the second panel 150. The second window 170 is defined by an edge 176 between the inner surface 156 and the outer surface 158. The second window 170 may be formed by stamping, cutting, punching or other metal forming process to form the edge 176 and the second window 170. In an exemplary embodiment, the second panel 150 includes a second shroud 178 partially or completely surrounding the second window 170. In the illustrated embodiment, the edge 176 may completely surround the second window 170. For example, the shroud 178 may be located above, below, forward of, and rearward of the second window 170. Alternatively, the shroud 178 may only partially surround the second window 170, such as being open above or below or forward of or rearward of the second window 170.

When formed (FIGS. 6 and 7), the power terminal 110 is folded in half at the folded seam 180 such that the first and second panels 120, 150 are arranged back to back. The inner surfaces 126, 156 of the first and second panels 120, 150 face each other. The folded seam 180 connects between the first and second panels 120, 150. For example, the folded seam 180 extends between the fixed edges 130, 160. The folded seam 180 may be U-shaped. However, the folded seam 180 may have other shapes in alternative embodiments.

When formed, the first window 140 receives the second contact bridge 172 and the second window 170 receives the first contact bridge 142 for termination to the power conductor. For example, the first protrusion 144 of the first contact bridge 142 protrudes through the second window 170 and the second protrusion 174 of the second contact bridge 172 protrudes through the first window 140. In an exemplary embodiment, the first window 140 receives the second contact bridge 172 such that the first panel 120 and the second contact bridge 172 are both configured to be terminated to the power conductor 102 when the power conductor 102 is at the first side 112 (FIG. 2). The second window 170 receives the first contact bridge 142 such that the second panel 150 and the first contact bridge 142 are both configured to be terminated to the power conductor 102 when the power conductor 102 is at the second side 114 (FIG. 3).

When formed, the power terminal 110 is configured to be terminated to the power conductor 102. For example, the power conductor 102 may be terminated to either the first side 112 (FIG. 2) or the second side 114 (FIG. 3). In an exemplary embodiment, the power terminal 110 is designed for efficient current flow between the power terminal 110 and the power conductor 102. For example, the power terminal 110 defines a composite surface at the first side 112 and the second side 114 integrating portions of both panels 120, 150 on each side 112, 114 to improve current flow. For example, the first contact bridge 142 is provided at the second side 114 and the second contact bridge 172 is provided at the first side 112 to allow direct electrical connection of the power conductor 102 to both the first panel 120 and the second panel 150 when connected to either side 112, 114. The power terminal 110 establishes efficient current flow to both the first panel 120 and the second panel 150 independent of the side that the power conductor 102 is connected to. For example, both panels 120, 150 of the power terminal 110 are involved in current conduction by allowing current flow through both panels 120, 150 directly, without traversing the folded seam 180.

In an exemplary embodiment, the first contact bridge 142 extends from the inner surface 126 of the first panel 120 and is received in the second window 170. The second contact bridge 172 extends from the inner surface 156 of the second panel 150 and is received in the first window 140. In an exemplary embodiment, the outer surface of the first contact bridge 142 is flush with the outer surface 158 of the second panel 150 and the outer surface of the second contact bridge 172 is flush with the outer surface 128 of the first panel 120. The first shroud 148 surrounds the second contact bridge 172 when the second contact bridge 172 is received in the first window 140. The second shroud 178 surrounds the first contact bridge 142 when the first contact bridge 142 is received in the second window 170. The first panel 120 (for example, the first shroud 148) and the second contact bridge 172 form a first terminating portion 190 at the first side 112 of the power terminal 110 configured to be terminated to the power conductor 102 when the power conductor 102 is at the first side 112 (FIG. 2). The second panel 150 (for example, the second shroud 178) and the first contact bridge 142 form a second terminating portion 192 at the second side 114 of the power terminal 110 configured to be terminated to the power conductor 102 when the power conductor 102 is at the second side 114.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power terminal assembly comprising:
a power terminal having a first panel and a second panel arranged back-to-back;
the first panel including a first mating end configured to be mated to a mating power terminal and a first terminating end configured to be terminated to a power conductor, the first panel including a first window at the first terminating end and a first contact bridge at the first terminating end;
the second panel including a second mating end configured to be mated to the mating power terminal and a second terminating end configured to be terminated to the power conductor, the second panel including a second window at the second terminating end and a second contact bridge at the second terminating end;
wherein the first window receives the second contact bridge and wherein the second window receives the first contact bridge for termination to the power conductor.

2. The power terminal assembly of claim 1, wherein the first contact bridge includes a first protrusion protruding through the second window, and wherein the second contact bridge includes a second protrusion protruding through the first window.

3. The power terminal assembly of claim 1, wherein the first panel includes an inner surface and an outer surface, the second panel including an inner surface and an outer surface, the inner surfaces of the first and second panels facing each other.

4. The power terminal assembly of claim 3, wherein the first contact bridge extends from the inner surface of the first panel and is received in the second window, and wherein the second contact bridge extends from the inner surface of the second panel and is received in the first window.

5. The power terminal assembly of claim 3, wherein the first contact bridge is flush with the outer surface of the second panel, and wherein the second contact bridge is flush with the outer surface of the first panel.

6. The power terminal assembly of claim 1, wherein the first panel and the second contact bridge form a first terminating portion at a first side of the power terminal configured to be terminated to the power conductor when the power conductor is at the first side, and wherein the second panel and the first contact bridge form a second terminating portion at a second side of the power terminal configured to be terminated to the power conductor when the power conductor is at the second side.

7. The power terminal assembly of claim 1, wherein the first panel includes a first shroud completely surrounding the first window and the second panel includes a second shroud completely surrounding the second window, the first shroud surrounding the second contact bridge when the second contact bridge is received in the first window, the second shroud surrounding the first contact bridge when the first contact bridge is received in the second window.

8. The power terminal assembly of claim 1, wherein the first contact bridge is adjacent to the first window and located axially offset along a terminal axis of the power terminal, and wherein the second contact bridge is adjacent to the second window and located axially offset along the terminal axis of the power terminal.

9. The power terminal assembly of claim 1, wherein the first contact bridge is adjacent to the first window and located laterally offset from the first window in a direction perpendicular to a terminal axis of the power terminal, and wherein the second contact bridge is adjacent to the second window and located laterally offset from the second window in a direction perpendicular to the terminal axis of the power terminal.

10. The power terminal assembly of claim 1, wherein the power terminal is folded in half at a folded seam such that the first and second panels are arranged back to back.

11. A power terminal assembly comprising:
a power conductor having a mating interface;
a power terminal terminated to the mating interface of the power conductor, the power terminal having a first panel at a first side of the power terminal and a second panel at a second side of the power terminal, the first and second panels arranged back-to-back;
the first panel including a first mating end configured to be mated to a mating power terminal and a first terminating end configured to be terminated to the power conductor, the first panel including a first window at the first terminating end and a first contact bridge at the first terminating end;
the second panel including a second mating end configured to be mated to the mating power terminal and a second terminating end configured to be terminated to the power conductor, the second panel including a second window at the second terminating end and a second contact bridge at the second terminating end;
wherein the first window receives the second contact bridge such that the first panel and the second contact bridge are both configured to be terminated to the power conductor when the power conductor is at the first side and wherein the second window receives the first contact bridge such that the second panel and the first contact bridge are both configured to be terminated to the power conductor when the power conductor is at the second side.

12. The power terminal assembly of claim 11, wherein the first contact bridge includes a first protrusion protruding through the second window, and wherein the second contact bridge includes a second protrusion protruding through the first window.

13. The power terminal assembly of claim 11, wherein the first panel includes an inner surface and an outer surface, the second panel including an inner surface and an outer surface, the inner surfaces of the first and second panels facing each other.

14. The power terminal assembly of claim 13, wherein the first contact bridge extends from the inner surface of the first panel and is received in the second window, and wherein the second contact bridge extends from the inner surface of the second panel and is received in the first window.

15. The power terminal assembly of claim 13, wherein the first contact bridge is flush with the outer surface of the second panel, and wherein the second contact bridge is flush with the outer surface of the first panel.

16. The power terminal assembly of claim 11, wherein the first panel and the second contact bridge form a first terminating portion at a first side of the power terminal configured to be terminated to the power conductor when the power conductor is at the first side, and wherein the second panel and the first contact bridge form a second terminating portion at a second side of the power terminal configured to be terminated to the power conductor when the power conductor is at the second side.

17. A power connector comprising:
a connector housing having a terminal channel; and
a power terminal received in the terminal channel and held by the connector housing, the power terminal including a power conductor having a mating interface and a power terminal terminated to the mating interface of the power conductor, the power terminal having a first panel at a first side of the power terminal and a second panel at a second side of the power terminal, the first and second panels arranged back-to-back;
the first panel including a first mating end configured to be mated to a mating power terminal and a first terminating end configured to be terminated to the power conductor, the first panel including a first window at the first terminating end and a first contact bridge at the first terminating end;
the second panel including a second mating end configured to be mated to the mating power terminal and a second terminating end configured to be terminated to the power conductor, the second panel including a second window at the second terminating end and a second contact bridge at the second terminating end;
wherein the first window receives the second contact bridge such that the first panel and the second contact bridge are both configured to be terminated to the power conductor when the power conductor is at the first side and wherein the second window receives the first contact bridge such that the second panel and the first contact bridge are both configured to be terminated to the power conductor when the power conductor is at the second side.

18. The power connector of claim 17, wherein the first contact bridge includes a first protrusion protruding through the second window, and wherein the second contact bridge includes a second protrusion protruding through the first window.

19. The power connector of claim 17, wherein the first panel includes an inner surface and an outer surface, the second panel including an inner surface and an outer surface, the inner surfaces of the first and second panels facing each other, the first contact bridge extending from the inner surface of the first panel and is received in the second window such that the first contact bridge is flush with the outer surface of the second panel, the second contact bridge extending from the inner surface of the second panel and is received in the first window such that the second contact bridge is flush with the outer surface of the first panel.

20. The power connector of claim 17, wherein the first panel and the second contact bridge form a first terminating portion at a first side of the power terminal configured to be terminated to the power conductor when the power conductor is at the first side, and wherein the second panel and the first contact bridge form a second terminating portion at a second side of the power terminal configured to be terminated to the power conductor when the power conductor is at the second side.
